(19) United States
(12) Patent Application Publication
(10) Pub. No.: US 2026/0299962 A1
(43) Pub. Date: Oct. 1, 2026

(54) ELECTRONIC DEVICE AND ELECTRONIC DEVICE CONTROL METHOD

(71) Applicant: SEIKO EPSON CORPORATION, Tokyo (JP)

(72) Inventor: Toshiyuki UTSUNOMIYA, Beppu-shi (JP)

(73) Assignee: SEIKO EPSON CORPORATION, Tokyo (JP)

(21) Appl. No.: 19/577,587

(22) Filed: Mar. 25, 2026

(30) Foreign Application Priority Data
Mar. 26, 2025 (JP) 2025-051240

(51) Int. Cl. G06F 9/4401; G06F 1/3206

(52) U.S. Cl. CPC G06F 9/4401; G06F 1/3206

(57) ABSTRACT

An electronic device includes: a first device; a second device different from the first device; an input device configured to receive an operation for controlling an operation of the first device; an operating system configured to control an operation of the second device; and a bootloader including software for controlling the operation of the first device based on a signal from the input device and configured to start the software when power is supplied from a power supply and start the operating system when a first condition different from the supply of the power from the power supply is satisfied.

The present application is based on, and claims priority from JP Application Serial Number 2025-051240, filed Mar. 26, 2025, the disclosure of which is hereby incorporated by reference herein in its entirety.

### BACKGROUND

### 1. Technical Field

The present disclosure relates to an electronic device and an electronic device control method.

### 2. Related Art

JP-A-2017-91996 discloses an illumination device including a light-emitting surface, a main light source, a projector, and a sub light source. The illumination device includes a controller configured to control a main power supply that supplies power to the main light source to light the main light source, a sub power supply that supplies power to the sub light source to light the sub light source, and the projector.

JP-A-2017-91996 is an example of the related art.

In the device disclosed in JP-A-2017-91996, since the controller controls the main light source, the projector, and the sub light source, even when any one of the main light source, the sub light source, and the projector is to be operated while the others are not required to be operated, the entire controller is required to be started, and power consumption is large.

### SUMMARY

An electronic device according to an aspect of the disclosure includes: a first device; a second device different from the first device; an input device configured to receive an operation for controlling an operation of the first device; an operating system configured to control an operation of the second device; and a bootloader including software for controlling the operation of the first device based on a signal from the input device and configured to start the software when power is supplied from a power supply and start the operating system when a first condition different from the supply of the power from the power supply is satisfied.

An electronic device according to another aspect of the disclosure includes: a first device; a second device different from the first device; a memory configured to store information indicating whether to operate the first device; an operating system; a bootloader configured to be started when power is supplied from a power supply and to start the operating system when the information indicates that the first device is to be operated; a first application configured to operate on the operating system and control an operation of the first device; and a second application configured to operate on the operating system and operate in a first mode that reduces power consumption of the second device when the information indicates that the first device is to be operated.

An electronic device control method according to an aspect of the disclosure includes: storing information indicating whether to operate a first device in an electronic device; starting a bootloader when power is supplied from a power supply; starting an operating system of the electronic device by the bootloader when the information indicates that the first device is to be operated; operating a first application that controls an operation of the first device on the operating system; and operating, when the information indicates that the first device is to be operated, a second application that controls an operation of a second device in the electronic device on the operating system, in a first mode that reduces power consumption of the second device.

### BRIEF DESCRIPTION OF THE DRAWINGS

FIG. 1 schematically shows a system used for an electronic device control method according to a first embodiment.

FIG. 2 is a block diagram of an electronic device according to the first embodiment.

FIG. 3 shows an example of a housing of the electronic device.

FIG. 4 shows a plurality of light sources provided in the housing shown in FIG. 3.

FIG. 5 shows a first function of an illumination device.

FIG. 6 shows a second function of the illumination device.

FIG. 7 is a flowchart showing a flow of the electronic device control method according to the first embodiment.

FIG. 8 is a block diagram of an electronic device according to a second embodiment.

FIG. 9 is a flowchart showing a flow of an electronic device control method according to the second embodiment.

### DESCRIPTION OF EMBODIMENTS

Preferred embodiments according to the disclosure will be described below with reference to the accompanying drawings. In the drawings, the dimensions and scales of units are different from actual ones as appropriate, and there may be parts schematically shown in order to facilitate understanding. The scope of the disclosure is not limited to the embodiments unless otherwise specifically stated in the following description.

### 1. First Embodiment

### 1-1. Overview of System

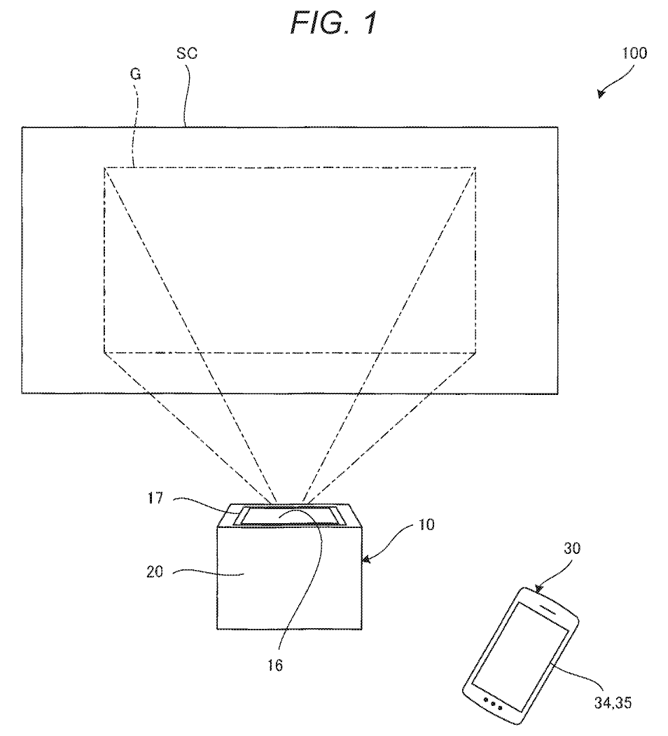

FIG. 1 schematically shows a system 100 used for a method for controlling an electronic device 10 according to a first embodiment. As shown in FIG. 1, the system 100 includes the electronic device 10 and a terminal apparatus 30. The terminal apparatus 30 is an example of an "external apparatus".

The electronic device 10 is an apparatus having a plurality of functions of different types. In the present embodiment, the electronic device 10 has an illumination function and a projection function of projecting an image G on a projection surface SC. The projection surface SC is an object such as a screen or a wall. The projection surface SC is not limited to a planar surface and may be, for example, a curved surface.

The electronic device 10 includes a housing 20, and an input device 16 and an illumination device 17 are disposed in the housing 20. The electronic device 10 causes a plurality of light sources 17a to be described later of the illumination device 17 to emit light in a light emission pattern and a light emission color based on control information DS to be described later. In addition, the electronic device 10 switches a combination of the light emission pattern and the light emission color of the plurality of light sources 17a to be described later, based on an input result of the input device 16. The light emission pattern is a temporal pattern of a combination of lighting and extinguishing of each of the plurality of light sources 17a. The light emission pattern may be referred to as a pattern of lighting and blinking of the plurality of light sources 17a. In the following description, information indicating a series of changes over time in the combination of the light emission pattern and the light emission color of the plurality of light sources 17a represented by the control information DS is associated with a control mode. This control mode may be referred to as a "mode" or a "light emission mode". The light emission mode of the plurality of light sources 17a may be referred to as a light emission mode of the illumination device 17.

The terminal apparatus 30 is an apparatus communicably connected to the electronic device 10. In the shown example, the terminal apparatus 30 is a smartphone. The terminal apparatus 30 has a function of controlling an operation of the electronic device 10 and a function of changing a setting of the electronic device 10. More specifically, the terminal apparatus 30 generates the control information DS to be described later and transmits the generated control information DS to the electronic device 10.

Here, the terminal apparatus 30 includes a display device 34 and an input device 35. The display device 34 is a display device including various display panels such as a liquid crystal display panel and an organic electro-luminescence (EL) display panel. The input device 35 is an input device that receives an operation from a user. In the shown example, the input device 35 is a touch panel and also serves as the display device 34.

The terminal apparatus 30 is not limited to the smartphone and may be, for example, a notebook or desktop computer, or a tablet terminal.

### 1-2. Electronic Device

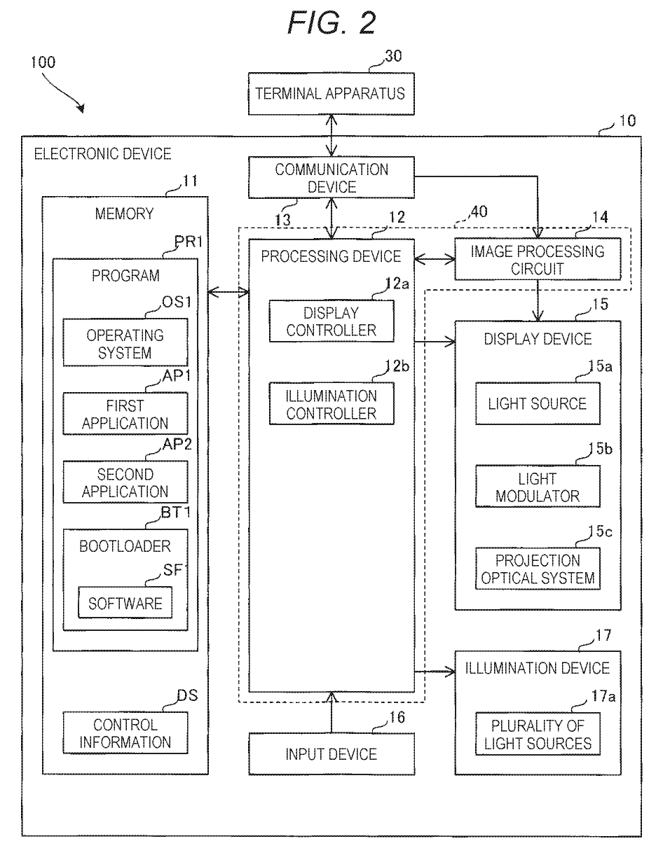

FIG. 2 is a block diagram of the electronic device 10 according to the first embodiment. As shown in FIG. 2, the electronic device 10 includes a memory 11, a processing device 12, a communication device 13, an image processing circuit 14, a display device 15, the input device 16, and the illumination device 17. These devices are communicably connected to each other. The illumination device 17 is an example of a "first device". The display device 15 is an example of a "second device".

The memory 11 is a storage device that stores a program to be executed by the processing device 12 and data to be processed by the processing device 12. The memory 11 includes, for example, a hard disk drive or a semiconductor memory. A part of the memory 11, other than an area for storing a bootloader BT1, may be provided in a storage device, a server, or the like outside the electronic device 10.

A program PR1 and the control information DS are stored in the memory 11. Each of these pieces of information may be divided and stored in a plurality of storage areas of the memory 11 or a plurality of storage devices.

The program PR1 is a program for executing a method for controlling the electronic device 10 to be described later. The program PR1 includes an operating system OS1, a first application AP1, a second application AP2, and the bootloader BT1. In this way, the electronic device 10 includes the operating system OS1, the first application AP1, the second application AP2, and the bootloader BT1.

The operating system OS1 is basic software for the electronic device 10. The first application AP1 is software that controls an operation of the illumination device 17 and operates on the operating system OS1. Accordingly, the operating system OS1 controls the operation of the illumination device 17 via the first application AP1. The second application AP2 is software that controls an operation of the display device 15 and operates on the operating system OS1. The second application AP2 may have a function of operating in a first mode for reducing power consumption of the display device 15 as in a second embodiment.

The bootloader BT1 is software that performs processing for starting the operating system OS1 when power is supplied from a power supply. The bootloader BT1 includes software SF. The software SF is software for controlling the operation of the illumination device 17 based on a signal from the input device 16, and operates as a part of the bootloader BT1.

The control information DS is information indicating a change over time in the light emission pattern and the light emission color of the plurality of light sources 17a. In the embodiment, the control information DS includes a plurality of pieces of information different from each other in the change over time in the light emission pattern and the light emission color. For example, the control information DS includes information indicating an identifier, a data set that is information indicating the light emission color and a combination of lighting and extinguishing of each of the plurality of light sources 17a at a certain time point, information indicating the number of data sets, information indicating a reading order of the data sets, information indicating the number of data sets to be applied per unit time, and information indicating the number of light sources 17a.

The processing device 12 is a processing device having a function of controlling the units of the electronic device 10 and a function of processing various data. The processing device 12 includes at least one processor such as a central processing unit (CPU). The processing device 12 may include a single processor or may include a plurality of processors. A part or all of the functions of the processing device 12 may be implemented by hardware such as a digital signal processor (DSP), an application-specific integrated circuit (ASIC), a programmable logic device (PLD), or a field-programmable gate array (FPGA). The processing device 12 may be integrated with the image processing circuit 14.

The communication device 13 is a communication device that can communicate with the external apparatus, and communicates with the terminal apparatus 30 and acquires video data from a device that is not shown. The communication device 13 is a wireless communication device such as low power wide area (LPWA), a wireless LAN including Wi-Fi, or Bluetooth. "Wi-Fi" and "Bluetooth" are registered trademarks. The communication device 13 is not limited to the wireless communication device and may be a wired communication device such as a wired local area network (LAN), a universal serial bus (USB), or a high-definition multimedia interface (HDMI). "HDMI" is a registered trademark.

The image processing circuit 14 is a circuit that performs required processing on the video data from the communication device 13 and inputs the processed video data to the display device 15. The image processing circuit 14 includes, for example, a frame memory (not shown), loads the video data in the frame memory, executes various types of processing such as resolution conversion processing, resizing processing, and distortion correction processing as appropriate, and inputs the processed video data to the display device 15. The image processing circuit 14 may execute, as necessary, processing such as on-screen display (OSD) processing of generating image information for a menu display, an operation guide, or the like and combining the image information with the video data.

The image processing circuit 14 functions as an information processing circuit 40 for operating the display device 15 together with the processing device 12.

The display device 15 is a device that displays an image and is different from the illumination device 17. In the embodiment, the display device 15 is a device that projects image light onto the projection surface SC, and includes a light source 15a, a light modulator 15b, and a projection optical system 15c.

The light source 15a includes a light source such as a halogen lamp, a xenon lamp, an ultrahigh-pressure mercury lamp, a light-emitting diode (LED), or a laser light source, and outputs red light, green light, and blue light. The light modulator 15b draws an image based on video data supplied from the terminal apparatus 30. The light modulator 15b includes three light modulation elements provided to correspond to red, green, and blue. The light modulation elements include, for example, transmissive liquid crystal panels, reflective liquid crystal panels, or digital mirror devices (DMDs) and modulate light of corresponding colors to generate image light of each color. The image light of each color generated by the light modulator 15b is combined by a color combining optical system to become full color image light. The projection optical system 15c is an optical system including a projection lens and the like that form an image of the full color image light from the light modulator 15b and projects the image onto the projection surface SC. The image drawn by the light modulator 15b, that is, a drawn image is projected onto the projection surface SC via the projection lens.

The input device 16 is a device that receives an operation from the user, and receives, for example, an operation for controlling the operation of the illumination device 17. In the embodiment, the input device 16 is a touch sensor. The input device 16 is not limited to the touch sensor and may be, for example, a proximity sensor, a button switch, or a slide bar.

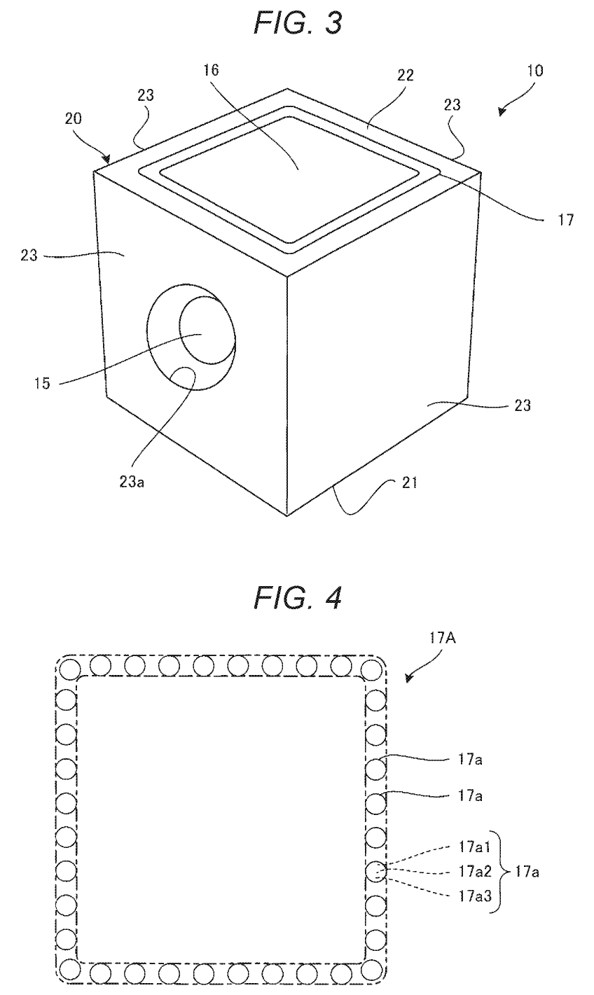

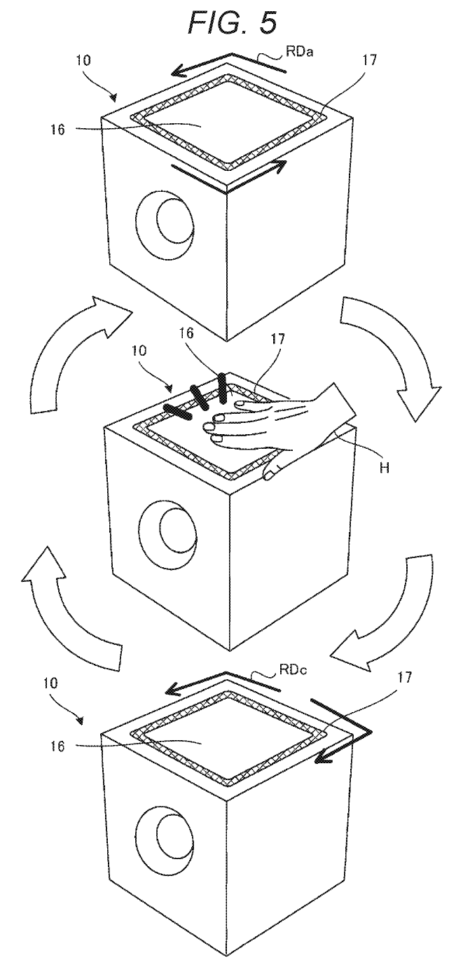

The illumination device 17 includes the plurality of light sources 17a. Each light source 17a is, for example, a light-emitting element such as a full color LED element that can change the light emission color and a brightness, and can change a luminance ratio of red light emission, green light emission, and blue light emission. Disposition of the plurality of light sources 17a will be described later with reference to FIGS. 3 and 4. In addition to the light-emitting element, the illumination device 17 may also include a drive circuit that drives the light-emitting element, or the like. The illumination device 17 may be referred to as a light-emitting element array, a light source array, a light source substrate, a light source module, or the like.

In the electronic device 10 described above, the processing device 12 executes the program PR1 stored in the memory 11 and thus functions as a projection controller 12a and an illumination controller 12b. Therefore, the electronic device 10 includes the projection controller 12a and the illumination controller 12b.

The projection controller 12a controls operations of the image processing circuit 14 and the display device 15. More specifically, the projection controller 12a controls the operations of the image processing circuit 14 and the display device 15 to project the image G onto the projection surface SC.

The illumination controller 12b controls driving of the illumination device 17. More specifically, the illumination controller 12b acquires the control information DS from the terminal apparatus 30 via the communication device 13 and causes the memory 11 to store the acquired control information DS. In addition, based on an input result of the terminal apparatus 30 or the input device 16, the illumination controller 12b controls a light emission state such as the brightness, the light emission pattern, or the light emission color of the illumination device 17 to a light emission state based on the control information DS.

### 1-3. Illumination Device

FIG. 3 shows an example of the housing 20 of the electronic device 10. In the example shown in FIG. 3, the housing 20 has a cubic shape having a bottom surface 21, a top surface 22, and four side surfaces 23. The input device 16, which is a touch sensor, and the illumination device 17 are provided at the top surface 22. One side surface 23 among the four side surfaces 23 is provided with an opening 23a for allowing projection from the display device 15.

The illumination device 17 has an annular shape that surrounds a periphery of the input device 16 along an outer peripheral edge of the top surface 22. The shape of the housing 20 is not limited to the shown example and is set as desired. In addition, aspects such as disposition, shape, and number of the illumination device 17 are not limited to the shown example and are set as desired.

FIG. 4 shows the plurality of light sources 17a provided in the housing 20 shown in FIG. 3. As shown in FIG. 4, the illumination device 17 includes the plurality of light sources 17a arranged along an annular shape. In the shown example, the number of light sources 17a provided in the illumination device 17 is 36. The number of light sources 17a provided in the illumination device 17 is not limited to the shown example and is set as desired.

Each light source 17a includes light-emitting elements 17a1, 17a2, 17a3. The light-emitting element 17a1 emits light having a first wavelength. The light-emitting element 17a2 emits light having a second wavelength different from the first wavelength. The light-emitting element 17a3 emits light having a third wavelength different from the first wavelength and the second wavelength. For example, the light-emitting element 17a1 emits red light, the light-emitting element 17a2 emits green light, and the light-emitting element 17a3 emits blue light. By changing a balance among light emission intensities of the light-emitting elements 17a1, 17a2, and 17a3, each light source 17a can be caused to emit light in full color.

The number of light-emitting elements in each light source 17a may be two or less or four or more. The plurality of light-emitting elements in each light source 17a may include a plurality of light-emitting elements that emit light of the same wavelength.

The plurality of light sources 17a provided in the illumination device 17 described above can individually control the light emission color and the brightness. Accordingly, the light emission pattern and the light emission color of the plurality of light sources 17a in the illumination device 17 can be variously changed.

### 1-4. First Function

FIG. 5 shows a first function of the illumination device 17. At the center in FIG. 5, the electronic device 10 before receiving the operation on the input device 16 is shown. On an upper side in FIG. 5, the electronic device 10 that causes the illumination device 17 to emit light in a light emission pattern and a light emission color of a first light emission mode after the operation on the input device 16 is received is shown. On a lower side in FIG. 5, the electronic device 10 that causes the illumination device 17 to emit light in a light emission pattern and a light emission color of a second light emission mode different from the first light emission mode after the operation on the input device 16 is received is shown. In FIG. 5, the illumination device 17 in a light emitting state is shaded.

Each of the software SF and the first application AP1 has the first function of controlling the operation of the illumination device 17 based on the signal from the input device 16. In the first function, when a predetermined operation is performed on the input device 16 as shown at the center in FIG. 5, a state where the illumination device 17 emits light in the light emission pattern and the light emission color of the first light emission mode and a state where the illumination device 17 emits light in the light emission pattern and the light emission color of the second light emission mode are alternately switched. In the example shown in FIG. 5, the predetermined operation is a long press touch operation by a hand H.

Here, in the example shown on the upper side in FIG. 5, bright and dark or the light emission color of the illumination device 17 changes to move along a peripheral direction RDa of the electronic device 10. In the example shown on the lower side in FIG. 5, the bright and dark or the light emission color of the illumination device 17 changes to move along a direction RDc toward the front of the electronic device 10. An aspect of the change in the light emission pattern and the light emission color of the illumination device 17 is not limited to the shown example, and is set as desired.

The predetermined operation on the input device 16 is not limited to the shown example, and, for example, when the input device 16 is a touch sensor that detects contact, the predetermined operation may be any one of a long press, a short press, a single tap, a double tap, a pinch operation, an operation of drawing a circle, scrolling in a first direction, and scrolling in a second direction different from the first direction on the touch sensor.

### 1-5. Second Function

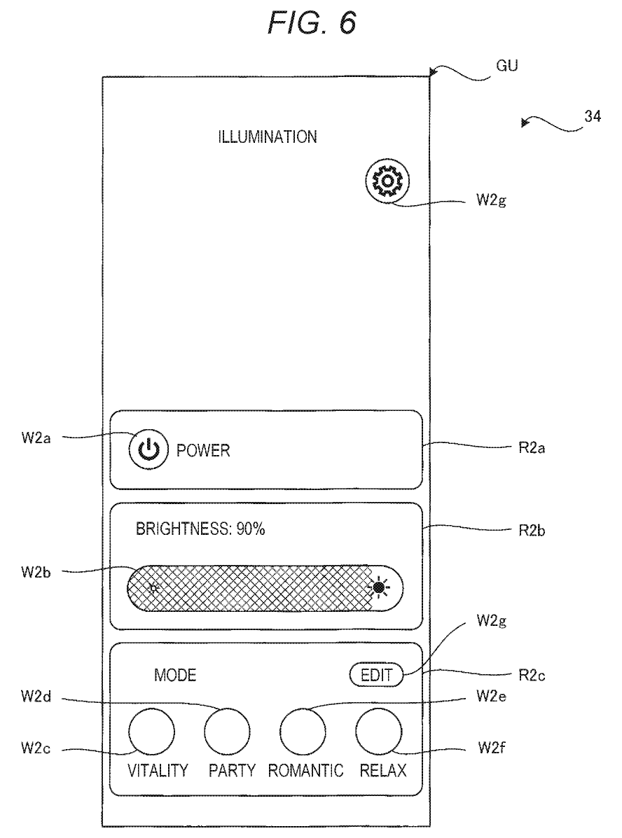

FIG. 6 shows a second function of the illumination device 17. FIG. 6 shows an example of an interface image GU displayed on the display device 34 of the terminal apparatus 30. An aspect of the interface image GU is not limited to the example shown in FIG. 6 and is set as desired.

In addition to the first function described above, the first application AP1 has the second function of controlling the operation of the illumination device 17 based on a signal from the communication device 13. Meanwhile, the software SF has the first function described above and does not have the second function. The software SF does not have a third function to be described later.

The interface image GU is a graphical user interface (GUI) for receiving an operation for controlling the operation of the illumination device 17, and is used for the second function. In the example shown in FIG. 6, the interface image GU includes areas R2a, R2b, and R2c, and a widget W2g.

The area R2a is an area related to power on and off of the illumination device 17, and includes a widget W2a. The widget W2a is an element that receives an operation of switching power on and off of the illumination device 17.

The area R2b is an area related to the brightness of the illumination device 17 and includes a widget W2b. The widget W2b is an element that receives an operation of adjusting the brightness of the illumination device 17.

The area R2c is an area related to the light emission pattern and the light emission color of the illumination device 17, and includes widgets W2c, W2d, W2e, W2f, and W2g. Each of the widgets W2c, W2d, W2e, and W2f is an element that receives an operation of selecting the light emission mode of the illumination device 17. The widget W2g is an element that receives an operation of editing the light emission mode of the illumination device 17. The light emission mode of the illumination device 17 is a combination of the light emission pattern and the light emission color of the illumination device 17. The number of selectable light emission modes is not limited to the shown example and is set as desired.

The widget W2g is an element that receives an operation related to another setting of the illumination device 17.

Through an operation on the interface image GU described above, a signal corresponding to operation content thereof is transmitted from the terminal apparatus 30 to the electronic device 10. The signal is received by the communication device 13 of the electronic device 10. Accordingly, the operation of the illumination device 17 is controlled based on the signal from the communication device 13.

The interface image GU may be displayed by the display device 15 of the electronic device 10. In this case, the first application AP1 has the third function of controlling the operation of the illumination device 17 based on an input via the interface image GU displayed on the display device 15. The first application AP1 may have both or either one of the second function and the third function.

As described above, the first application AP1 has at least two functions including the first function among the first function, the second function, and the third function, whereas the software SF has the first function and does not have the second function and the third function. In this way, it is possible to obtain the first application AP1 that is more multifunctional than the software SF that controls the operation of the illumination device 17. This is because the software SF operating on the bootloader BT1 is functionally limited due to a control target scope of the bootloader BT1, whereas the first application AP1 operating on the operating system OS1 has no such limitations.

### 1-6. Electronic Device Control Method

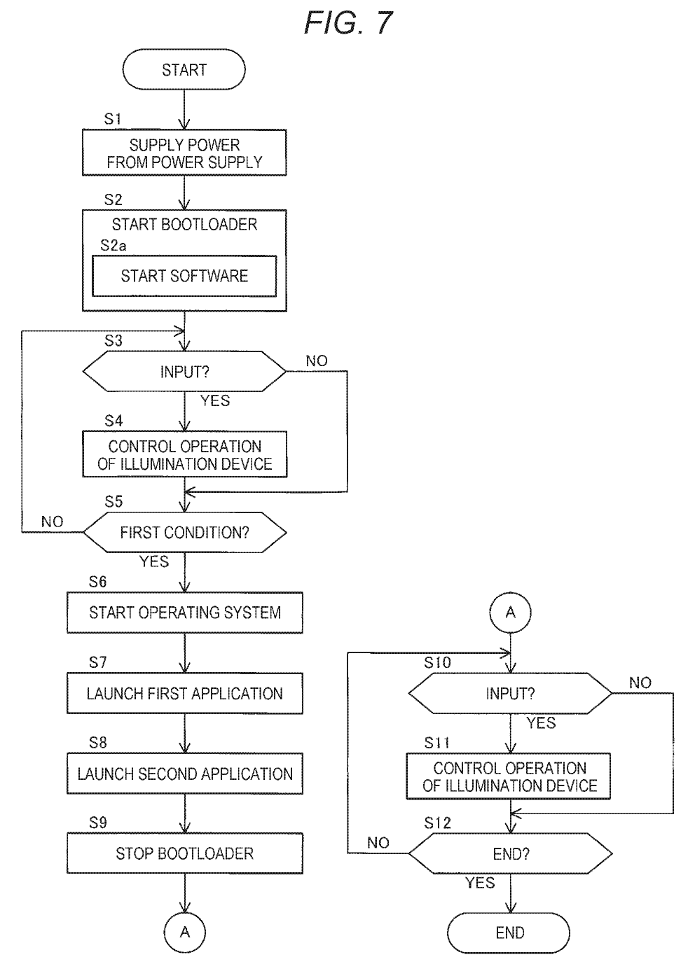

FIG. 7 is a flowchart showing a flow of a method for controlling the electronic device 10 according to the first embodiment. In the electronic device 10, first, when power is supplied to the electronic device 10 from the power supply such as a commercial power supply (not shown) (step S1), in step S2, the processing device 12 reads the bootloader BT1 from the memory 11 and executes the bootloader BT1 to start the bootloader BT1. Step S2 includes step S2a. In step S2a, the processing device 12 starts the software SF. Accordingly, it is possible to control the operation of the illumination device 17 based on the signal from the input device 16.

After step S2, in step S3, the processing device 12 determines whether there is an input by the predetermined operation described above on the input device 16.

When the input is performed (step S3: YES), in step S4, the processing device 12 controls the operation of the illumination device 17 to emit light in the first light emission mode or the second light emission mode described above based on the signal from the input device 16.

On the other hand, when the input is not performed (step S3: NO) or after step S4, in step S5, the processing device 12 determines whether a first condition different from the supply of the power from the power supply is satisfied.

The first condition is, for example, that the bootloader BT1 receives a power-on interrupt signal. Accordingly, the operating system OS1 can be started in response to the power-on interrupt signal. The power-on is performed, for example, by pressing a power switch provided at the housing 20.

When the first condition is not satisfied (step S5: NO), the processing device 12 returns to step S3. Accordingly, the operation of the illumination device 17 can be controlled by the operation on the input device 16 until the first condition is satisfied.

On the other hand, when the first condition is satisfied (step S5: YES), in step S6, the processing device 12 starts the operating system OS1. In this way, the bootloader BT1 starts the software SF (step S2a) when the power is supplied from the power supply (step S1), and starts the operating system OS1 (step S6) when the first condition is satisfied (step S5).

After step S6, in step S7, the processing device 12 launches the first application AP1 by the operating system OS1. In this way, when the first condition is satisfied (step S5: YES), the operating system OS1 launches the first application AP1 (step S7).

After step S7, in step S8, the processing device 12 launches the second application AP2 by the operating system OS1. In this way, when the first condition is satisfied (step S5: YES), the operating system OS1 launches the second application AP2 (step S8).

After step S8, in step S9, the processing device 12 stops the bootloader BT1. In this way, when the first condition is satisfied (step S5: YES), the bootloader BT1 is stopped (step S9). In this way, since the bootloader BT1 is stopped after the first application AP1 is launched, the operation of the illumination device 17 can be controlled even after the operating system OS1 is started.

After step S9, in step S10, the processing device 12 determines whether there is an input by the above-described predetermined operation on the input device 16 or the input to the communication device 13 using the interface image GU described above.

When the input is performed (step S10: YES), in step S11, the processing device 12 controls the operation of the illumination device 17 to emit light in the first light emission mode or the second light emission mode described above based on the signal from the input device 16, or controls the operation of the illumination device 17 based on the operation on the interface image GU described above.

On the other hand, when the input is not performed (step S10: NO) or after step S11, in step S12, the processing device 12 determines whether to end the processing. Such determination is performed based on, for example, a user operation on the terminal apparatus 30 or the input device 16.

When the processing is not to be ended (step S12: NO), the processing device 12 returns to step S10. Accordingly, it is possible to control the operation of the illumination device 17 by the operation on the input device 16 or the interface image GU.

On the other hand, when the processing is to be ended (step S12: YES), the processing device 12 ends the processing.

As described above, in the electronic device 10, since the software SF that controls the operation of the illumination device 17 based on the signal from the input device 16 is provided in the bootloader BT1, the software SF can be started when the power is supplied from the power supply. Accordingly, it is possible to control the operation of the illumination device 17 based on the signal from the input device 16 in response to the supply of the power from the power supply. Even when the power is supplied from the power supply, the operating system OS1 that controls the operation of the display device 15 is not started unless the first condition different from the supply of the power from the power supply is satisfied, and thus it is possible to save power when only the illumination device 17 is to be used.

Since the electronic device 10 includes the illumination device 17 and the display device 15 as described above, the electronic device 10 having the illumination function and a display function can be obtained. In addition, it is possible to perform illumination by the illumination device 17 while reducing power consumption by the display device 15.

### 2. Second Embodiment

The second embodiment of the disclosure will hereinafter be described. Hereinafter, differences from the first embodiment will be mainly described, and descriptions of the same matters as those in the first embodiment will be omitted.

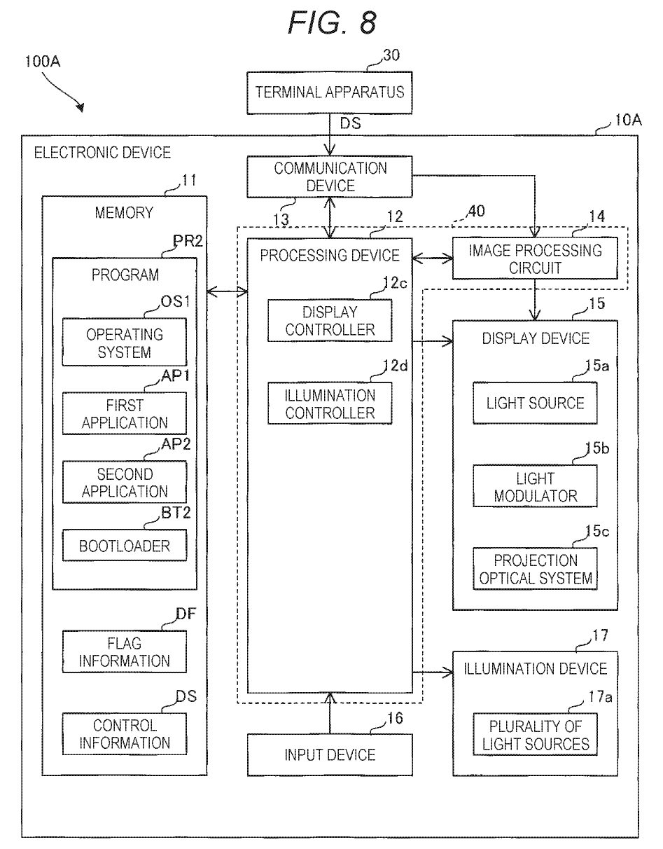

FIG. 8 is a block diagram of an electronic device 10A according to the second embodiment. A system 100A of the embodiment is the same as the system 100 of the first embodiment except that the electronic device 10A is provided instead of the electronic device 10 of the first embodiment. The electronic device 10A is the same as the electronic device 10 of the first embodiment except that a program PR2 is used instead of the program PR1 of the first embodiment and flag information DF is used.

Therefore, the electronic device 10A includes the illumination device 17, the display device 15, the memory 11, the operating system OS1, a bootloader BT2, the first application AP1, and the second application AP2. Here, the memory 11 stores the flag information DF.

The program PR2 is the same as the program PR1 of the first embodiment except that the bootloader BT2 is provided instead of the bootloader BT1 of the first embodiment. However, the second application AP2 has the function of operating in the first mode for reducing the power consumption of the display device 15. The bootloader BT2 is the same as the bootloader BT1 of the first embodiment except that the software SF of the first embodiment is not provided.

The flag information DF is information indicating whether to operate the illumination device 17. As will be described later, the flag information DF is stored in the memory 11 when processing of the electronic device 10A ends.

Here, the bootloader BT2 is started when the power is supplied from the power supply, and starts the operating system OS1 when the flag information DF indicates that the illumination device 17 is to be operated. The second application AP2 operates on the operating system OS1 and operates in the first mode for reducing the power consumption of the display device 15 when the flag information DF indicates that the illumination device 17 is to be operated.

In the electronic device 10A, the processing device 12 executes the program PR2 stored in the memory 11 and thus functions as a projection controller 12c and an illumination controller 12d. Therefore, the electronic device 10A includes the projection controller 12c and the illumination controller 12d.

The projection controller 12c is the same as the projection controller 12a in the first embodiment except that the first mode in which the power consumption of the display device 15 is reduced by the second application AP2 can be executed.

The illumination controller 12d is the same as the illumination controller 12b of the first embodiment except that the control by the software SF of the first embodiment is not executed and control using the flag information DF is performed.

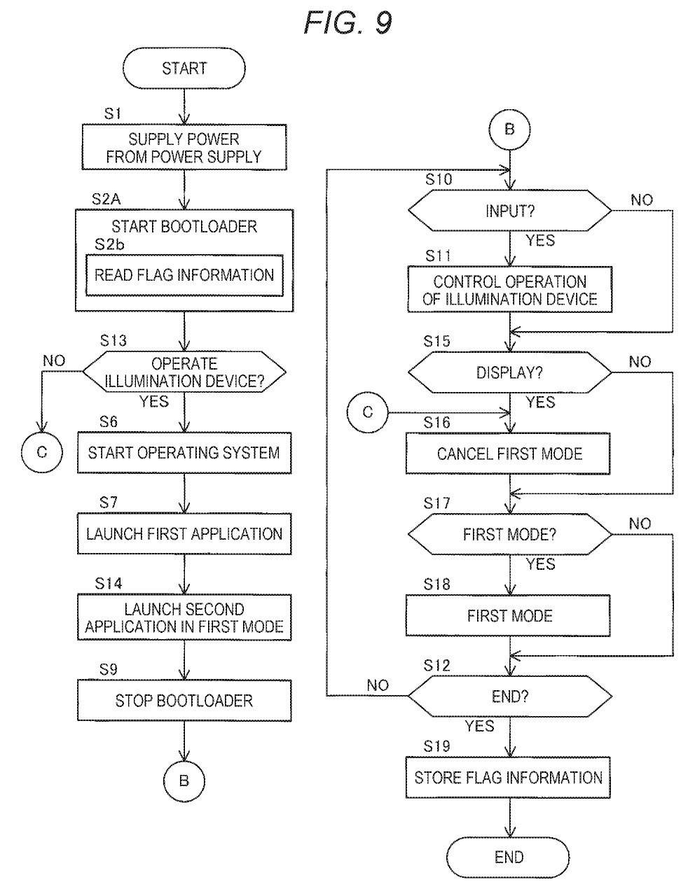

FIG. 9 is a flowchart showing a flow of a method for controlling the electronic device 10A according to the second embodiment. In FIG. 9, the same components as those in FIG. 7 described above are denoted by the same reference signs.

In the electronic device 10A, first, when power is supplied to the electronic device 10A from a power supply such as a commercial power supply (not shown) (step S1), in step S2A, the processing device 12 reads the bootloader BT2 from the memory 11 and executes the bootloader BT2 to start the bootloader BT2. Step S2A includes step S2b. In step S2b, the processing device 12 reads the latest flag information DF from the memory 11. In this way, in step S2A, when the power is supplied from the power supply (step S1), the processing device 12 starts the bootloader BT2.

The flag information DF is stored in the memory 11 in step S19 as will be described later when the electronic device 10A is used last time, or is stored in the memory 11 when the electronic device 10A is manufactured.

After step S2A, in step S13, the processing device 12 determines whether to operate the illumination device 17 based on the flag information DF.

When the illumination device 17 is to be operated (step S13: YES), the processing device 12 executes steps S6 and S7 as in the first embodiment, and then starts the second application AP2 in the first mode in step S14. The first mode is a power saving mode for reducing the power consumption of the display device 15.

In the first mode, the second application AP2 performs one or both of stopping control for operating the display device 15 and stopping the supply of the power to at least a part of the information processing circuit 40 for operating the display device 15. Accordingly, in the first mode, the power consumption of the display device 15 can be reduced.

In this way, when the flag information DF indicates that the illumination device 17 is to be operated in step S6 (step S13: YES), the bootloader BT2 starts the operating system OS1 of the electronic device 10, the first application AP1 operates on the operating system OS1 in step S7, and when the flag information DF indicates that the illumination device 17 is to be operated (step S13: YES), the second application AP2 operates in the first mode on the operating system OS1 in step S14.

After step S14, the processing device 12 executes steps S9, S10, and S11 as in the first embodiment. Here, in step S9, the processing device 12 stops the bootloader BT2.

In this way, in step S10, the processing device 12 receives, from the user, an input indicating that the illumination device 17 is to be operated without operating the display device 15 during a period in which the operating system OS1 is running.

When no input is performed on the input device 16 (step S10: NO) or after step S11, in step S15, the processing device 12 determines whether to perform a display on the display device 15. Such determination is performed in the same manner as whether the first condition of the first embodiment is satisfied.

When the display device 15 performs the display (step S15: YES), in step S16, the processing device 12 cancels the first mode by the second application AP2. Alternatively, when the illumination device 17 is not to be operated (step S13: NO), in step S16, the processing device 12 starts the operating system OS1 and then launches the second application AP2 in the state where the first mode is canceled.

On the other hand, when the display device 15 does not perform the display (step S15: NO) or after step S16, in step S17, the processing device 12 determines whether to execute the first mode. Such determination is performed based on, for example, a user operation on the terminal apparatus 30 or the input device 16.

When the first mode is executed (step S17: YES), in step S18, the processing device 12 executes the first mode by the second application AP2.

When the first mode is not executed (step S17: NO) or after step S18, step S12 is executed as in the first embodiment.

In the embodiment, when the processing ends (step S12: YES), in step S19, the processing device 12 stores the flag information DF in the memory 11 and then ends the processing. In step S19, the processing device 12 stores the flag information DF indicating that the illumination device 17 is to be operated in the memory 11 when the first mode is executed immediately before step S19 is executed, and stores the flag information DF indicating that the illumination device 17 is not to be operated in the memory 11 when the first mode is not executed immediately before step S19 is executed. Accordingly, the latest flag information DF stored in the memory 11 is updated.

In this way, in step S19, when the input is received (step S10: NO), the processing device 12 stores the flag information DF indicating that the illumination device 17 is to be operated in the memory 11. Accordingly, when the electronic device 10A is powered on next time, the illumination device 17 can be operated without operating the display device 15 in response to the input from the user.

Instead of step S19, the processing device 12 may store and update the flag information DF indicating that the illumination device 17 is to be operated in the memory 11 in step S14 or step S18, or may store and update the flag information DF indicating that the illumination device 17 is not to be operated in the memory 11 in step S16.

As described above, in the electronic device 10A, when the power is supplied from the power supply and the flag information DF indicates that the illumination device 17 is to be operated (step S2, step S13: YES), the bootloader BT2 starts the operating system OS1 in step S6, and thus the first application AP1 that controls the operation of the illumination device 17 can be operated on the operating system OS1. Accordingly, it is possible to control the operation of the illumination device 17 based on the signal from the input device 16 in response to the supply of the power from the power supply. Even when the second application AP2 operates on the operating system OS1 in step S14, when the flag information DF indicates that the illumination device 17 is to be operated (step S13: YES), the second application AP2 operates in the first mode in which the power consumption of the display device 15 is reduced in step S14, and thus it is possible to save power when only the illumination device 17 is to be used.

### 3. Modification

Each aspect shown as examples above can be variously modified. Specific aspects of modifications applicable to each aspect described above are shown below as examples. Two or more aspects optionally selected from the following examples can be combined as appropriate to an extent that no contradiction occurs.

### 3-1. Modification 1

In the embodiment described above, an aspect in which the electronic device 10 includes the illumination device 17 as the "first device" and the display device 15 as the "second device" is shown as an example, but the disclosure is not limited to this aspect, and the technique of the disclosure is applicable to various electronic devices including a plurality of devices of different types.

For example, the electronic device 10 may be a display apparatus including a speaker as the "first device" and the display device 15 as the "second device", an air conditioner including the speaker as the "first device" and an air conditioner as the "second device", or an illumination apparatus including the speaker as the "first device" and the illumination device 17 as the "second device".

The illumination device 17 is not limited to the aspect of the embodiment described above, and may be, for example, illumination light or a light-emitting diode (LED) light band.

The display device 15 is not limited to the projection device described above, and may be, for example, a display device such as a liquid crystal display device or an organic EL display device.

### 3-2. Modification 2

In the embodiment described above, an aspect in which the terminal apparatus 30 performs the setting and control of one electronic device 10 is shown as an example, but the present disclosure is not limited to this aspect, and the terminal apparatus 30 may perform the setting and control of a plurality of electronic devices 10.

### 3-3. Modification 3

The programs PR1 and PR2 in the embodiment described above may be provided in a state of being recorded on a computer-readable non-transitory recording medium. Alternatively, the programs PR1 and PR2 in the embodiment described above may be provided in a form of being downloaded from a server to the computer through a network.

### 4. Appendices

The disclosure will be summarized below as appendices.

(Appendix 1) Appendix 1 that is a preferred example of an electronic device of the disclosure includes: a first device; a second device different from the first device; an input device configured to receive an operation for controlling an operation of the first device; an operating system configured to control an operation of the second device; and a bootloader including software for controlling the operation of the first device based on a signal from the input device and configured to start the software when power is supplied from a power supply and start the operating system when a first condition different from the supply of the power from the power supply is satisfied.

In the above aspect, since the software that controls the operation of the first device based on the signal from the input device is provided in the bootloader, the software can be started when the power is supplied from the power supply. Accordingly, it is possible to control the operation of the first device based on the signal from the input device in response to the supply of the power from the power supply. Even when the power is supplied from the power supply, the operating system that controls the operation of the second device is not started unless the first condition different from the supply of the power from the power supply is satisfied, and thus it is possible to save power when only the first device is to be used.

(Appendix 2) Appendix 2 that is a preferred example of Appendix 1 further includes: a second application configured to operate on the operating system and control the operation of the second device, in which the first device is an illumination device, and the second device is a display device for displaying an image. In the above aspect, it is possible to obtain an electronic device having an illumination function and a display function. In addition, it is possible to perform illumination by the illumination device while reducing power consumption by the display device.

(Appendix 3) Appendix 3 that is a preferred example of Appendix 1 or Appendix 2 further includes: a first application configured to operate on the operating system and control the operation of the first device, in which, when the first condition is satisfied, the bootloader starts the operating system, the operating system launches the first application, and the bootloader is stopped. In the above aspect, the operation of the first device can be controlled even after the operating system is started.

(Appendix 4) Appendix 4 that is a preferred example of Appendix 3 further includes: a communication device configured to communicate with an external apparatus; and a display device configured to display an image, in which, among a first function of controlling the operation of the first device based on the signal from the input device, a second function of controlling the operation of the first device based on a signal from the communication device, and a third function of controlling the operation of the first device based on an input via an interface image displayed on the display device, the first application has at least two functions including the first function, and the software has the first function and does not have the second function and the third function. In the above aspect, it is possible to obtain the first application that is more multifunctional than the software that controls the operation of the first device.

(Appendix 5) In Appendix 5 that is a preferred example of any one of Appendix 1 to Appendix 4, the first condition is that the bootloader receives a power-on interrupt signal. In the above aspect, the operating system can be started in response to the power-on interrupt signal.

(Appendix 6) Appendix 6 that is a preferred example of an electronic device of the disclosure includes: a first device; a second device different from the first device; a memory configured to store information indicating whether to operate the first device; an operating system; a bootloader configured to be started when power is supplied from a power supply and to start the operating system when the information indicates that the first device is to be operated; a first application configured to operate on the operating system and control an operation of the first device; and a second application configured to operate on the operating system and operate in a first mode that reduces power consumption of the second device when the information indicates that the first device is to be operated.

In the above aspect, when the power is supplied from the power supply and the information indicates that the first device is to be operated, the bootloader starts the operating system, and thus the first application that controls the operation of the first device can be operated on the operating system. Accordingly, it is possible to control the operation of the first device based on the signal from the input device in response to the supply of the power from the power supply. In addition, even when the second application operates on the operating system, when the information indicates that the first device is to be operated, the second application operates in the first mode in which the power consumption of the second device is reduced, and thus it is possible to save power when only the first device is to be used.

(Appendix 7) Appendix 7 that is a preferred example of an electronic device control method of the disclosure includes: storing information indicating whether to operate a first device in an electronic device; starting a bootloader when power is supplied from a power supply; starting an operating system of the electronic device by the bootloader when the information indicates that the first device is to be operated; operating a first application that controls an operation of the first device on the operating system; and operating, when the information indicates that the first device is to be operated, a second application that controls an operation of a second device in the electronic device on the operating system, in a first mode that reduces power consumption of the second device.

In the above aspect, when the power is supplied from the power supply and the information indicates that the first device is to be operated, the bootloader starts the operating system, and thus the first application that controls the operation of the first device can be operated on the operating system. Accordingly, it is possible to control the operation of the first device based on the signal from the input device in response to the supply of the power from the power supply. In addition, even when the second application operates on the operating system, when the information indicates that the first device is to be operated, the second application operates in the first mode in which the power consumption of the second device is reduced, and thus it is possible to save power when only the first device is to be used.

(Appendix 8) Appendix 8 that is a preferred example of Appendix 7 includes: receiving, from a user, an input indicating that the first device is to be operated without operating the second device during a period in which the operating system is running, in which storing the information includes storing information indicating that the first device is to be operated when the input is received. In the above aspect, when the electronic device is powered on next time, the first device can be operated without operating the second device in response to the input from the user.

(Appendix 9) In Appendix 9 that is a preferred example of Appendix 7 or Appendix 8, in the first mode, the second application performs one or both of stopping control for operating the second device, and stopping the supply of the power to at least a part of an information processing circuit for operating the second device. In the above aspect, the power consumption of the second device can be reduced in the first mode.

What is claimed is:

1. An electronic device comprising:
a first device;
a second device different from the first device;
an input device configured to receive an operation for controlling an operation of the first device;
an operating system configured to control an operation of the second device; and
a bootloader including software for controlling the operation of the first device based on a signal from the input device and configured to start the software when power is supplied from a power supply and start the operating system when a first condition different from the supply of the power from the power supply is satisfied.

2. The electronic device according to claim 1, further comprising:
a second application configured to operate on the operating system and control the operation of the second device, wherein
the first device is an illumination device, and
the second device is a display device for displaying an image.

3. The electronic device according to claim 1, further comprising:
a first application configured to operate on the operating system and control the operation of the first device, wherein
when the first condition is satisfied,
the bootloader starts the operating system,
the operating system launches the first application, and
the bootloader is stopped.

4. The electronic device according to claim 3, further comprising:
a communication device configured to communicate with an external apparatus; and
a display device configured to display an image, wherein
among a first function of controlling the operation of the first device based on the signal from the input device, a second function of controlling the operation of the first device based on a signal from the communication device, and a third function of controlling the operation of the first device based on an input via an interface image displayed on the display device, the first application has at least two functions including the first function, and
the software has the first function and does not have the second function and the third function.

5. The electronic device according to claim 1, wherein
the first condition is that the bootloader receives a power-on interrupt signal.

6. An electronic device comprising:
a first device;
a second device different from the first device;
a memory configured to store information indicating whether to operate the first device;
an operating system;
a bootloader configured to be started when power is supplied from a power supply and to start the operating system when the information indicates that the first device is to be operated;
a first application configured to operate on the operating system and control an operation of the first device; and
a second application configured to operate on the operating system and operate in a first mode that reduces power consumption of the second device when the information indicates that the first device is to be operated.

7. An electronic device control method comprising:
storing information indicating whether to operate a first device in an electronic device;
starting a bootloader when power is supplied from a power supply;
starting an operating system of the electronic device by the bootloader when the information indicates that the first device is to be operated;
operating a first application that controls an operation of the first device on the operating system; and
operating, when the information indicates that the first device is to be operated, a second application that controls an operation of a second device in the electronic device on the operating system, in a first mode that reduces power consumption of the second device.

8. The electronic device control method according to claim 7, further comprising:
receiving, from a user, an input indicating that the first device is to be operated without operating the second device during a period in which the operating system is running, wherein
storing the information includes storing information indicating that the first device is to be operated when the input is received.

9. The electronic device control method according to claim 7, wherein
in the first mode, the second application performs one or both of
stopping control for operating the second device, and
stopping the supply of the power to at least a part of an information processing circuit for operating the second device.
